(19) United States
(12) Patent Application Publication
(10) Pub. No.: US 2016/0049893 A1
(43) Pub. Date: Feb. 18, 2016

(54) APPARATUS FOR DRIVING MOTOR AND CONTROLLING METHOD THEREOF

(71) Applicant: Samsung Electro-Mechanics Co., Ltd., Suwon-si (KR)

(72) Inventors: Joung Ho SON, Suwon-si (KR); Mu Seon WOO, Suwon-si (KR); Dae Sung KIM, Suwon-si (KR); Bok Young HONG, Suwon-si (KR)

(73) Assignee: Samsung Electro-Mechanics Co., Ltd., Suwon-si (KR)

(21) Appl. No.: 14/818,758

(22) Filed: Aug. 5, 2015

(30) Foreign Application Priority Data
Aug. 12, 2014 (KR) 10-2014-0104552

(51) Int. Cl. H02P 25/08

(52) U.S. Cl. CPC H02P 25/085

(57) ABSTRACT

There is provided an apparatus for driving a switched reluctance motor (SRM), including: a motor driver applying a input voltage supplied from a power supply unit to phase windings of the SRM through a switching operation; and a processor controlling the switching operation of the motor driver depending on a driving state of the SRM.

### CROSS-REFERENCE TO RELATED APPLICATION

This application claims the benefit of Korean Patent Application No. 10-2014-0104552, filed on Aug. 12, 2014, entitled “Apparatus for Driving Motor and Controlling Method Thereof” which is hereby incorporated by reference in its entirety into this application.

### BACKGROUND

The present disclosure relates to an apparatus for driving a motor and a controlling method thereof.

In a switched reluctance motor (hereinafter, referred to as a SRM), which is a motor having a form in which it has a switching control apparatus coupled thereto, both of a stator and a rotor have a salient pole type structure.

Particularly, since only a stator part has a winding wound therearound and a rotor part does not include any type winding or permanent magnet, a structure of the SRM is simple.

Due to this structural feature, the SRM has a significant advantage in terms of manufacturing and production, and has good start-up characteristics and a large torque, similar to a direct current motor. In addition, the SRM requires less maintenance and has excellent characteristics in terms of a torque per unit volume, efficiency, rating of a converter, and the like, such that the use of the SRM has gradually increased in various fields.

The SRM as described above may have various types such as a single-phase, a two-phase, a three-phase, and the like. Among others, the two-phase SRM has a driving circuit simpler than that of the three-phase SRM, such that it has been significantly prominent in applications such as a fan, a blower, a compressor, and the like.

### RELATED ART DOCUMENT

### Patent Document

(Patent Document 1) 10-271885JP

### SUMMARY

An aspect of the present disclosure may provide an apparatus for driving a motor capable of solving a problem such as electrical damage, or the like, to an electrical component, or the like, due to an overcurrent that may be generated in a control circuit of a switched reluctance motor (SRM) in the case in which input power is temporarily blocked into an acceleration section, or the like, of the SRM and is then applied again in driving the SRM, and a controlling method thereof.

In an apparatus for driving an SRM and a controlling method thereof according to an exemplary embodiment of the present disclosure, a processor may forcibly convert a driving state of the SRM into a stop state STOP through comparison between an input voltage input from a power supply unit and a preset reference voltage.

Therefore, the processor may compare the input voltage and the preset reference voltage with each other to control the driving state of the SRM. The processor may initialize the driving state of the SRM in the case in which the input voltage is the reference voltage or less, and maintain the driving state of the SRM in the casein which the input voltage exceeds the reference voltage.

In more detail, a controller may transmit a control signal for converting the driving state of the SRM into the stop state to a pulse width modulation (PWM) signal generating module in the case in which the input voltage is the reference voltage or less.

In addition, the PWM signal generating module may initialize a duty ratio of a PWM signal applied to a motor driver based on the control signal.

Therefore, in the case in which power is turned off, the driving state of the SRM may be converted into the stop state, such that a rapid increase in a current in a control circuit of the SRM that may be generated in the case in which the power is again applied is prevented, thereby making it possible to prevent electrical damage, or the like, to an electrical device, or the like, of the control device.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram illustrating an apparatus for driving a switched reluctance motor (SRM) according to an exemplary embodiment of the present disclosure;

FIGS. 2A to 2D are views illustrating a current loop depending on a switching operation of a motor driver according to the exemplary embodiment of the present disclosure;

FIG. 3A is a view illustrating a phase current of the SRM according to the exemplary embodiment of the present disclosure; and FIG. 3B is a view illustrating an input current of the SRM according to the exemplary embodiment of the present disclosure;

FIG. 4A is a view illustrating changes in a sensed voltage of a voltage sensing unit and an input voltage of a processor according to the exemplary embodiment of the present disclosure; and FIG. 4B is a view illustrating a change in an input voltage according to the exemplary embodiment of the present disclosure; and

FIG. 5 is a flow chart illustrating a controlling method of an apparatus for driving an SRM according to the exemplary embodiment of the present disclosure.

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, an apparatus for driving a motor and a controlling method thereof according to an exemplary embodiment of the present disclosure will be described in detail with reference to the accompanying drawings. Here, the motor means a two-phase switched reluctance motor (hereinafter, referred to as an SRM). Here, although the SRM will be described based on a two-phase (A phase and B phase), this description may also be applied to the case in which the SRM has two or more phase windings.

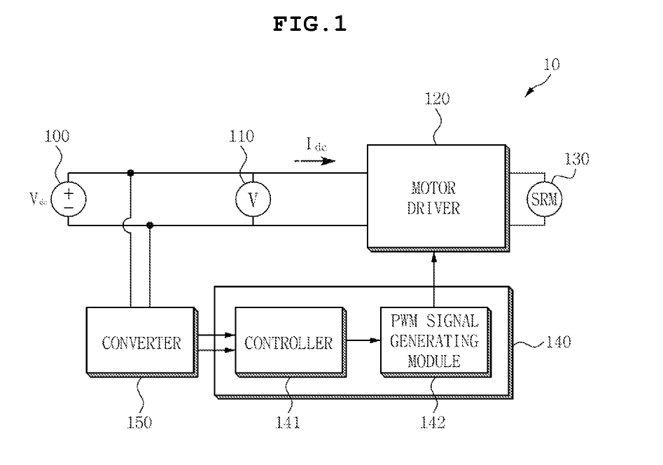

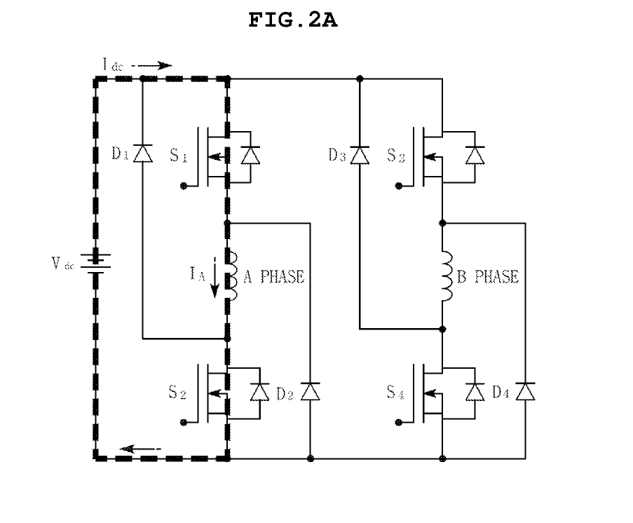

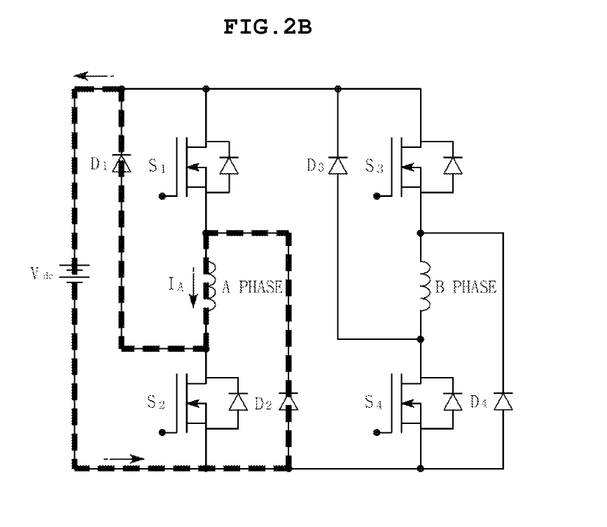

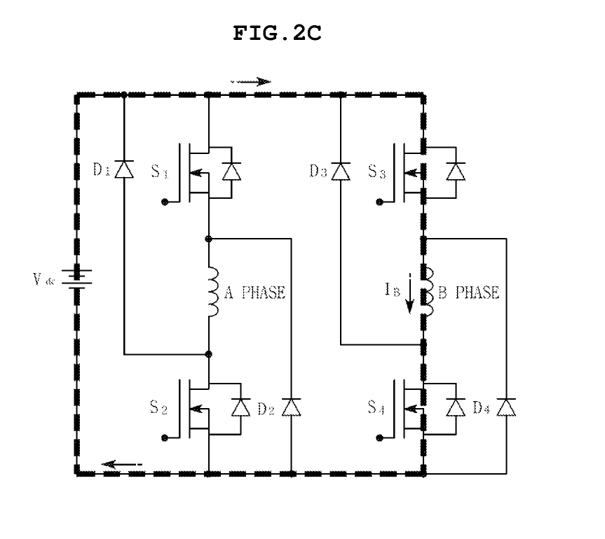

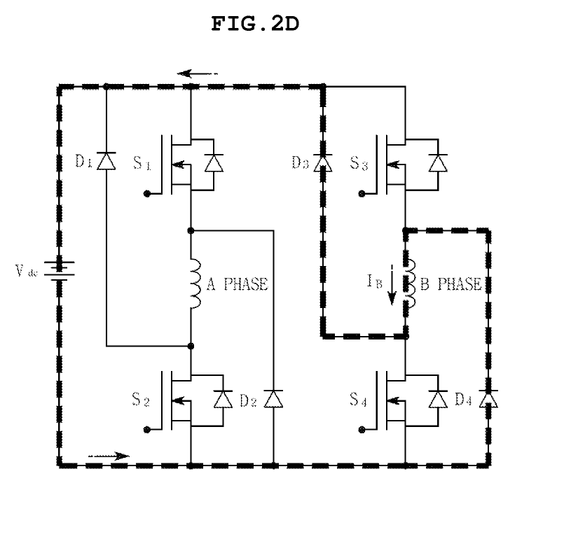

FIG. 1 is a block diagram illustrating an apparatus for driving an SRM according to an exemplary embodiment of the present disclosure; and FIGS. 2A to 2D are views illustrating a current loop depending on a switching operation of a motor driver according to the exemplary embodiment of the present disclosure.

As illustrated in FIG. 1, the apparatus 100 for driving an SRM according to the exemplary embodiment of the present disclosure may be configured to include a power supply unit 100, a voltage sensor 110, a converter 150, a motor driver 120, and a processor 140.

The power supply unit 100 may provide an input voltage (direct current (DC) voltage) for driving the SRM, and provide a DC type voltage. Here, the input voltage (DC voltage) may be a voltage created by converting an alternating current (AC) type voltage into a DC voltage through a rectifying unit (not illustrated) or a DC voltage supplied through a battery and having a predetermined magnitude, but is not limited thereto.

The rectifying unit (not illustrated) may include a smoothing capacitor smoothing the AC voltage (improving a power factor of the AC voltage and absorbing noise) and a bridge rectifying circuit rectifying the smoothed AC voltage into a DC voltage.

The motor driver 120 applies the input voltage (DC voltage) to each phase of the SRM 130 through a switching operation. In addition, the motor driver 120 includes a switching unit S1 to S4 applying the input voltage (DC voltage) to each phase winding of the SRM 130 through the switching operation and a current circulating unit D1 to D4 circulating currents flowing to each phase winding of the SRM 130 in predetermined directions during the switching operation.

As illustrated in FIG. 2A, the switching unit S1 to S4 includes a first switch S1 connected in series with an upper portion of any one phase winding (A phase winding) of the SRM 130, a second switch S2 connected in series with a lower portion of any one phase winding (A phase winding) of the SRM 130, a third switch S3 connected in series with an upper portion of the other phase winding (B phase winding) of the SRM 130, and a fourth switch S4 connected in series with a lower portion of the other phase winding (b phase winding) of the SRM 130.

The current circulating unit D1 to D4 circulates the currents flowing to each phase winding of the SRM 130 in the predetermined directions, and includes first to fourth diodes D1 to D4. In addition, 1) the first diode D1 has a positive electrode connected to a contact point between the A phase winding and the second switch S2 and a negative electrode connected to the power supply unit 100, and 2) the second diode D2 has a positive electrode connected to a contact point between the A phase winding and the first switch S1 and a negative electrode connected to a ground terminal GND.

In addition, 3) the third diode D3 has a positive electrode connected to a contact point between the B phase winding and the fourth switch S4 and a negative electrode connected to the power supply unit 100, and 3) the fourth diode D4 has a positive electrode connected to a contact point between the B phase winding and the third switch S3 and a negative electrode connected to the ground terminal GND.

Here, \textcircled{1} as illustrated in FIG. 2A, in the case in which the first and second switches S1 and S2 are turned on, a closed loop configured of the first and second switches S1 and S2 is formed. In addition, the input voltage V_{dc} is applied to the A phase winding through the closed loop. As a result, a phase current I_{A} flows in the closed loop, and energy is transferred to the A phase winding.

In addition, \textcircled{2} as illustrated in FIG. 2B, in the case in which the first and second switches S1 and S2 are turned off, a closed loop configured of the first and second diodes D1 and D2 and the A phase winding is formed. In addition, a circulation current I_{A} flows through the closed loop, and is decreased by speed electromotive force.

\textcircled{3} as illustrated in FIG. 2C, in the case in which the third and fourth switches S3 and S4 are turned on, a closed loop configured of the third and fourth switches S3 and S4 is formed. In addition, the input voltage V_{dc} is applied to the B phase winding through the closed loop. As a result, a phase current I_{B} flows in the closed loop, and energy is transferred to the B phase winding.

\textcircled{4} as illustrated in FIG. 2D, in the case in which the third and fourth switches S3 and S4 are turned off, a closed loop configured of the third and fourth diodes D3 and D4 and the B phase winding is formed. In addition, a circulation current I_{B} flows through the closed loop, and is gradually decreased by speed electromotive force.

The converter 150 converts (bucks or boosts) the DC voltage input from the power supply unit 100 into a preset voltage having a predetermined magnitude, and applies the preset output voltage to the processor 140. Here, the preset output voltage, which is a driving voltage of the processor 140, may be about 3.3V, and the DC voltage, which is a driving voltage of the SRM, may be about 25V, but are not limited thereto.

The processor 140 controls the switching operation of the motor driver 120 depending on a driving state (a position and a speed of a rotor (not illustrated)) of the SRM 130. That is, the processor 140 controls the switching operations of the switching unit S1 to S4 and the current circulating unit D1 to D4 of the motor driver 120 depending on the driving state of the SRM 140 to control the DC voltage to be sequentially applied to each phase winding of the SRM 140.

Here, the processor 140 may be a micro controller unit (MCU), and includes a pulse width modulation (PWM) signal generating module 142 generating PWM signals that are to be applied to first and second upper/lower switches S1 to S4 of the motor driver 120 and a controller 141 generating control signals for controlling the PWM signal generating module 142.

In addition, the processor 140 senses a magnitude of the input voltage (DC) applied from the power supply unit 100 through the voltage sensor 110, and compares the input voltage and a preset reference voltage with each other. That is, the processor 140 initializes the driving state of the SRM in the case in which the input voltage is the reference voltage or less, and maintains the driving state of the SRM in the casein which the input voltage exceeds the reference voltage.

Here, the reference voltage may be a minimum driving voltage at which a battery may be driven in the case in which the power supplying unit 100 is the battery supplying a DC voltage having a predetermined magnitude, and may be about 17V, but is not limited thereto.

In more detail, the controller 141 transmits a control signal for converting the driving state of the SRM 130 into a stop state STOP to the PWM signal generating module 142 in the case in which the input voltage is the reference voltage or less.

In addition, the PWM signal generating module 142 initializes a duty ratio of the PWM signal applied to the motor driver 120 based on the control signal.

For example, in the case in which power applied to a driving circuit 10 of the SRM is turned off, the controller 141 compares the input voltage sensed through the voltage sensor 110 and the reference voltage with each other, and generates the control signal for converting the driving state of the SRM 130 into the stop state STOP and transmits the control signal to the PWM signal generating module 142, in the case in which the input voltage is the reference voltage or less.

In addition, the PWM signal generating module 142 initializes (0%) the duty ratio of the PWM signal applied to the motor driver 120 based on the control signal. Therefore, the driving of the SRM 130 is stopped.

Further, in the case in which the power applied to the driving circuit 10 of the SRM is again turned on, the controller 141 transmits a control signal for initial driving of the SRM 130 to the PWM signal generating module 142, and the PWM signal generating module 142 applies the PWM signals to the switching unit S1 to S4 of the motor driver 120. Here, a duty ratio of the PWM signal is increased from 5%, but is not limited thereto.

The processor 140, the controller 141, and the PWM signal generating module 142 described above may include an algorithm for performing the functions described above, and may be implemented by firmware, software, or hardware (for example, a semiconductor chip or an application-specific integrated circuit).

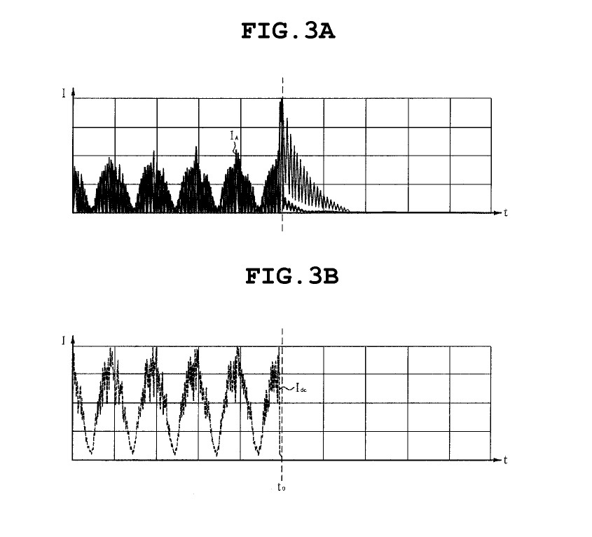

Next, a controlling method of an apparatus for driving an SRM according to the exemplary embodiment of the present disclosure will be described in more detail with reference to FIGS. 3A to 5.

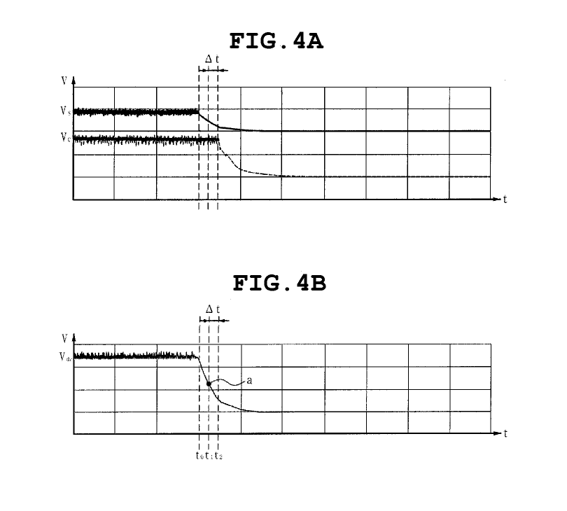

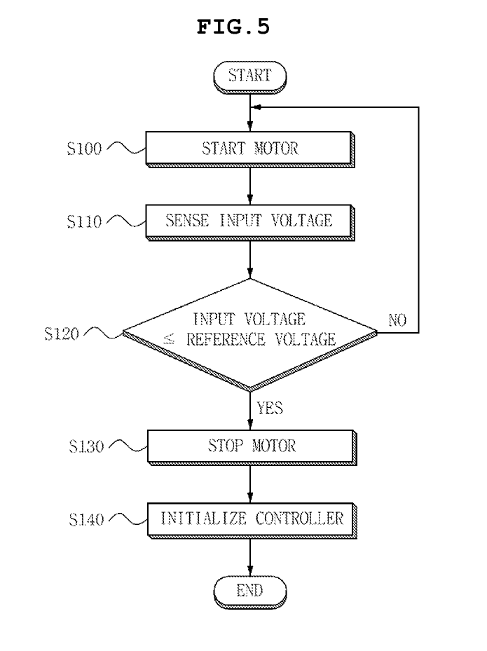

FIG. 3A is a view illustrating a phase current of the SRM according to the exemplary embodiment of the present disclosure; and FIG. 3B is a view illustrating an input current of the SRM according to the exemplary embodiment of the present disclosure. FIG. 4A is a view illustrating changes in a sensed voltage of a voltage sensing unit and an input voltage of a processor according to the exemplary embodiment of the present disclosure; and FIG. 4B is a view illustrating a change in an input voltage according to the exemplary embodiment of the present disclosure. FIG. 5 is a flow chart illustrating a controlling method of an apparatus for driving an SRM according to the exemplary embodiment of the present disclosure.

First, as illustrated in FIGS. 3A and 3B, in the case in which power is turned off (t₀) when the SRM 130 is being normally driven (single pulse control), an input current I_{dc} applied from the power supply unit 100 is cut off, while a phase current I_{A} flowing to the A phase winding may be maintained for a predetermined time. This is due to a circulation current (See FIG. 3) flowing to each phase winding of the SRM 130.

In addition, as illustrated in FIGS. 4A and 4B, in the case in which power is turned off (t₀) when the SRM 130 is being normally driven (single pulse control), an input Voltage V_{dc} applied from the power supply unit 100 is rapidly decreased from a point in time in which the power is turned off, while an output voltage V_{C} applied to the processor 140 is maintained for a predetermined time Δt.

Therefore, the processor 140 controls the driving of the SRM 130 at a constant velocity for the predetermined time Δt.

However, in the case in which the power is again turned on before the processor 140 initializes the driving state of the SRM 130 to a stop state (in a state in which a speed of the rotor (not illustrated) of the SRM 130 is significantly decreased), a high current (surge current) in which a PWM duty is increased flows to a control circuit.

That is, a supplied current is rapidly increased as compared with a current consumed at the time of driving the SRM 130, such that electronic elements (insulated gate bipolar transistor (IGBT), diode, and the like) may be damaged due the increased current.

Therefore, as illustrated in FIG. 5, in the controlling method of an apparatus for driving an SRM according to the exemplary embodiment of the present disclosure, the driving state of the SRM 130 is forcibly converted into the stop state STOP by the processor 140 by comparing the input voltage input from the power supply unit 100 and the preset reference voltage with each other in order to solve the above-mentioned technical problem.

First, the controlling method of an apparatus for driving an SRM according to the exemplary embodiment of the present disclosure includes a driving step (S100) of applying, by the motor driver 120, the input voltage supplied from the power supply unit to the phase windings of the SRM through the switching operation, and a driving control step of controlling, by the processor 140, the switching operation of the motor driver 120 depending on the driving state of the SRM 130.

That is, the switching unit S1 to S4 applies the input voltage to the phase windings of the SRM 130 through the switching operations, and the current circulating unit D1 to D4 circulates the currents flowing to the phase winding of the SRM 130 in predetermined directions during the switching operations.

Next, the voltage sensor 110 senses the input voltage (S110), and the processor 140 compares the input voltage and the preset reference voltage with each other to control the driving state of the SRM 130.

That is, the processor 140 stops the driving of the SRM (S130) and initializes the driving state of the SRM (S140), in the case in which the input voltage is the reference voltage (for example, 17V) or less (point a of FIG. 4B), and maintains the driving state of the SRM 130 in the case in which the input voltage exceeds the reference voltage.

In more detail, the controller 141 transmits the control signal for converting the driving state of the SRM 130 into the stop state to the PWM signal generating module 142. The PWM signal generating module 142 turns off the switching operation of the motor driver 120 based on the control signal to stop the driving of the SRM 130 (S130).

Then, the controller 141 initializes the duty ratio of the PWM signal, and again performs a control of an initial PWM signal to drive the SRM 130 in the case in which the power is turned off.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. An apparatus for driving a switched reluctance motor (SRM), comprising:
a motor driver applying a input voltage supplied from a power supply unit to phase windings of the SRM through a switching operation; and
a processor controlling a driving state of the SRM based on the input voltage.

2. The apparatus for driving an SRM of claim 1, wherein the motor driver includes:
a switching unit applying the input voltage to each phase winding of the SRM through the switching operation; and
a current circulating unit circulating currents flowing to each phase winding of the SRM in predetermined directions during the switching operation.

3. The apparatus for driving an SRM of claim 1, further comprising a converter converting the input voltage into a preset output voltage and applying the converted output voltage to the processor.

4. The apparatus for driving an SRM of claim 1, wherein the processor compares the input voltage and a preset reference voltage with each other to control the driving state of the SRM.

5. The apparatus for driving an SRM of claim 4, wherein the processor converts the driving state of the SRM into a stop state in the case in which the input voltage is the reference voltage or less, and maintains the driving state of the SRM in the case in which the input voltage exceeds the reference voltage.

6. The apparatus for driving an SRM of claim 4, wherein the processor includes:
a controller controlling the switching operation of the motor driver depending on the driving state of the SRM; and
a pulse width modulation (PWM) signal generating module generating a PWM signal for controlling the switching operation of the motor driver based on a control signal applied from the controller and applying the generated PWM signal to the motor driver.

7. The apparatus for driving an SRM of claim 6, wherein the controller transmits a control signal for converting the driving state of the SRM into a stop state to the PWM signal generating module in the case in which the input voltage is the reference voltage or less, and
the PWM signal generating module initializes a duty ratio of the PWM signal applied to the motor driver based on the control signal.

8. The apparatus for driving an SRM of claim 7, wherein the power supply unit is a battery, and
the reference voltage is a minimum driving voltage of the battery.

9. A controlling method of an apparatus for driving an SRM, comprising:
a driving step of applying, by a motor driver, an input voltage supplied from a power supply unit to phase windings of the SRM through a switching operation; and
a driving control step of controlling, by a processor, the driving state of the SRM based on the input voltage.

10. The controlling method of an apparatus for driving an SRM of claim 9, wherein the driving step includes:
a step of applying, by a switching unit, the input voltage to the phase windings of the SRM through the switching operation; and
a step of circulating, by a current circulating unit, currents flowing to the phase winding of the SRM in predetermined directions during the switching operation.

11. The controlling method of an apparatus for driving an SRM of claim 9, wherein the driving control step includes:
a step of sensing the input voltage; and
a step of controlling the driving state of the SRM by comparing the input voltage and a preset reference voltage with each other.

12. The controlling method of an apparatus for driving an SRM of claim 11, wherein the step of controlling the driving state of the SRM includes:
a step of converting the driving state of the SRM into a stop state in the case in which the input voltage is the reference voltage or less; and
a step of maintaining the driving state of the SRM in the case in which the input voltage exceeds the reference voltage.

13. The controlling method of an apparatus for driving an SRM of claim 12, wherein the step of converting the driving state of the SRM into the stop state includes:
a step of transmitting, by a controller, a control signal for converting the driving state of the SRM into the stop state to a PWM signal generating module; and
a step of initializing, by the PWM signal generating module, a duty ratio of a PWM signal applied to the motor driver based on the control signal.
